(19) United States
(12) Patent Application Publication
(10) Pub. No.: US 2007/0140754 A1
(43) Pub. Date: Jun. 21, 2007

(54) Reusable web cleaning system for a fuser

(75) Inventors: John Poxon, Stevenage (GB); Scott Potter, Welwyn Garden City (GB); Pieter Mulder, Welwyn Garden City (GB)

Correspondence Address: Ann M. Skerry, Esq.;FAY, SHARPE, FAGAN, MINNICH & McKEE, LLP, SEVENTH FLOOR, 1100 SUPERIOR AVENUE, CLEVELAND, OH, 44114-2579, US

(73) Assignee: XEROX CORPORATION.

(21) Appl. No.: 11/314,253

(22) Filed: Dec. 21, 2005

(51) Int. Cl. G03G 15/20

(52) U.S. Cl. 399/327

(57) ABSTRACT

A fuser system includes first and second nip rolls, rotably mounted parallel to and in contact with each other to form a nip through which print media with a toner image thereon is passed to fuse the image to the print media. A cleaning web system is provided for cleaning one of the nip rolls of unfused toner. The cleaning web system includes first and second rotatable web rolls. A web extends between the first and second web rolls and contacts the first nip roll. A drive system is operatively coupled with one or both of the first and second web rolls for advancing the web in a first direction and thereafter in a second direction opposite the first direction.

### BACKGROUND

The present exemplary embodiment relates to a cleaning system for a cylindrical roller and, more particularly, to a fuser apparatus for an electrophotographic device, which includes a web cleaning system for cleaning the fuser roll, thereby reducing toner retransfer. It will be appreciated, however, that the web cleaning system finds application in the cleaning or in liquid application treatment of other cylindrical rollers.

In typical electrophotographic image forming devices, such as copy machines and laser beam printers, a photoconductive insulating member is charged to a uniform potential and thereafter exposed to a light image of an original document to be reproduced. The exposure discharges the photoconductive insulating surface in exposed or background areas and creates an electrostatic latent image on the member, which corresponds to the image areas contained within the document. Subsequently, the electrostatic latent image on the photoconductive insulating surface is made visible by developing the image with a marking material. Generally, the marking material comprises pigmented toner particles adhering triboelectrically to carrier granules, which is often referred to simply as toner. The developed image is subsequently transferred to the print medium, such as a sheet of paper. The fusing of the toner image onto paper is generally accomplished by applying heat and pressure. A typical fuser assembly includes a fuser roll and a pressure roll, which define a nip therebetween. The side of the paper having the toner image typically faces the fuser roll, which is often supplied with a heat source, such as a resistance heater, at the core thereof. The combination of heat from the fuser roll and pressure between the fuser roll and the pressure roll fuses the toner image to the paper, and once the fused toner cools, the image is permanently fixed to the paper.

Fuser assemblies typically include a cleaning system by which the fuser roll can be automatically cleaned and/or supplied with a lubricant or release agent. In some cleaning devices, a cloth web is urged against the surface of the fuser roll at a location generally away from the nip formed by the pressure and fuser rolls. The web provides a textured surface for removing particles of toner that remained on the fuser roll after the paper with the toner image has passed through the fuser. The web may also be impregnated to provide amounts of lubricant or release agent to the fuser roll. Release agents generally function to prevent sheets of paper from sticking to the surface of the fuser roll, thus causing a paper jam. The release agents may also serve to minimize the amount of toner that sticks to the fuser roll. After a predetermined number of reproductions have been printed, the web is advanced a few millimeters from a supply roll towards an uptake roll to provide a clean web surface in contact with the surface to be cleaned.

Where high volumes of similar images or high area coverage images are to be printed and fused, there is a tendency for toner to build up on the web and hamper subsequent cleaning of the fuser roll. The toner on a saturated web may be transferred back to the fuser roll and be deposited on a subsequent sheet. This can cause visible defects in the printed copies.

### CROSS REFERENCE TO RELATED PATENTS AND APPLICATIONS

The following references, the disclosures of which are incorporated herein in their entireties by reference, are mentioned:

U.S. application Ser. No. ______ (Attorney docket No. 20051228-US-NP), filed contemporaneously herewith, entitled “MULTIVARIATE PREDICTIVE CONTROL OF FUSER TEMPERATURES,” by Pieter Mulder, et al. U.S. application Ser. No. ______ (Attorney docket No. 20051231-US-NP), filed contemporaneously herewith, entitled “AXIALLY TRANSLATING WEB CLEANING SYSTEM FOR A FUSER,” by John Poxon, et al.

### INCORPORATION BY REFERENCE

The following references, the disclosures of which are incorporated herein in their entireties by reference, are mentioned:

U.S. Pat. No. 5,049,944 to DeBolt, et al. discloses a web cleaning system including a control system for varying the duty cycle of a take up roll.

U.S. Pat. No. 6,876,832 to Pirwitz, et al. discloses a fuser apparatus which includes a web cleaning system which is configured for prevention of inadvertent spooling of a fuser cleaning web during a jam clearance.

### BRIEF DESCRIPTION

Aspects of the exemplary embodiment relate to a fuser system, to a web cleaning system, a method of cleaning a nip roll, and to a method of advancing a web.

In one aspect, a fuser system includes first and second nip rolls, rotatably mounted parallel to and in contact with each other to form a nip through which print media with a toner image thereon is passed to fuse the image to the print media. A cleaning web system is provided for cleaning the first nip roll. The cleaning web system includes first and second rotatable web rolls. A web extends between the first and second web rolls and contacts the first nip roll. A drive system is operatively coupled with at least one of the first and second web rolls for advancing the web in a first direction and thereafter in a second direction opposite the first direction.

In another aspect, a method of cleaning a nip roll of a fuser includes advancing a web in a first direction, advancing the web in a second direction opposite the first direction, and biasing the web into contact with a rotating nip roll during the advancement of the web in the first and second directions.

In another aspect, a web cleaning system includes a length of web and a first web roll and a second web roll which support ends of the web thereon. A tension roll, intermediate the first and second web rolls, biases the web into contact with an associated nip roll. A drive system, operatively connected with the web rolls, advances the web in a first direction then advances the web in a second direction opposite the first direction. An end of web detection system, coupled with the drive system, detects an end of the web.

### BRIEF DESCRIPTION OF THE DRAWINGS

FIG. 1 is a schematic view of a printing system according to the exemplary embodiment;

FIG. 2 is a schematic cross sectional view of a first embodiment of the web cleaning system of FIG. 1;

FIG. 3 is a schematic view of the web cleaning system of FIG. 2 transporting the web in a first direction;

FIG. 4 is a schematic view of the web cleaning system of FIG. 2 transporting the web in a direction opposite the first direction;

FIG. 5 is a schematic cross sectional view of a second embodiment of the web cleaning system of FIG. 1;

FIG. 6 is a schematic view of the web cleaning system of FIG. 5 transporting the web in a first direction;

FIG. 7 is a schematic view of the web cleaning system of FIG. 5 transporting the web in a direction opposite the first direction;

FIG. 8 is a schematic cross sectional view of a third embodiment of the web cleaning system of FIG. 1;

FIG. 9 is a schematic view of the web cleaning system of FIG. 8 transporting the web in a first direction;

FIG. 10 is a schematic view of the web cleaning system of FIG. 8 transporting the web in a direction opposite the first direction;

FIG. 11 is a perspective view of a first embodiment of an end of web detection system;

FIG. 12 is a side sectional view of the end of web detection system of FIG. 11;

FIG. 13 is a side sectional view of a second embodiment of a web detection system;

FIG. 14 is a flow diagram of an exemplary method of advancing a web;

FIG. 15 illustrates toner contamination on a web advanced at normal speed;

FIG. 16 illustrates toner contamination on a high speed web;

FIG. 17 is a plot of exemplary contamination density for a web of a conventional cleaning system; and

FIG. 18 is a plot of exemplary contamination density for a web which has undergone multiple passes in a fast moving web system according to the exemplary embodiment.

### DETAILED DESCRIPTION

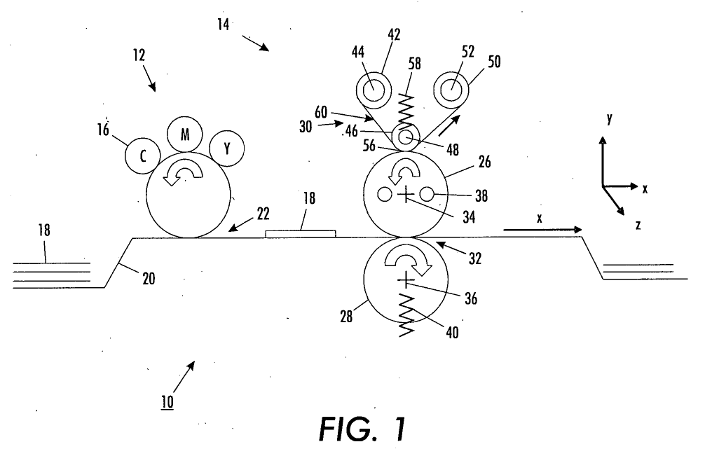

With reference to FIG. 1, an electrophotographic printing system 10 includes an image applying component 12, which applies a toner image to print media by the steps of latent image formation, development, and transfer, and a fusing system 14 which fuses the applied image to the print media. The image applying component includes one or more toner sources 16, cyan, magenta, and yellow (C, M, Y) in the illustrated embodiment. The exemplary printing system 10 may include a variety of other components, such as finishers, paper feeders, and the like, and may be embodied as a copier, printer, bookmaking machine, facsimile machine, or a multifunction machine. “Print media” can be a usually flimsy physical sheet of paper, plastic, or other suitable physical print media substrate for images. A “print job” or “document” is normally a set of related sheets, usually one or more collated copy sets copied from a set of original print job sheets or electronic document page images, from a particular user, or otherwise related. An image generally may include information in electronic form which is to be rendered on the print media by the marking engine and may include text, graphics, pictures, and the like. A “finisher” can be any post-printing accessory device, such as a tray or trays, sorter, mailbox, inserter, interposer, folder, stapler, stacker, hole puncher, collater, stitcher, binder, envelope stuffer, postage machine, or the like. The operation of applying images to print media, for example, graphics, text, photographs, etc., is generally referred to herein as printing or marking.

The fusing system 14 (or simply “fuser”) generally includes a pair of nip rolls, such as a fuser roll 2 and a pressure roll 28, and a web cleaning system 30. The fuser roll 26 and pressure roll 28 are rotatably mounted in a fuser housing (not shown) and are aligned parallel to and in contact with each other to form a nip 32 through which the print media, such as paper 18, with a toner image thereon (not shown) is passed, as in the direction of arrow x. The fuser roll and pressure roll are rotated about respective axes of symmetry 34, 36 aligned generally perpendicular with the process direction, in the direction of arrow z. The fuser roll 26 is heated by a heating system 38, illustrated as a pair of heat lamps aligned parallel to the axis 34 of the fuser roll 26. A drive system (not shown) rotates the fuser and pressure rolls 26, 28 in the directions shown in FIG. 1. For example, the fuser roll may be driven at about 300 mm per second. The pressure roll 28 is urged into contact with the fuser roll 26 by a constant spring force, indicated by arrow 40.

The fuser roll 26 may include a rigid cylindrical sleeve, formed from aluminum or other suitable metal, that is hollow and has a wall thickness about 5 mm, or less. The pressure roll 28 may include a cylindrical conformable roll which includes a metal core, such as steel, with a layer of silicone rubber or other conformable material on its outer surface that is covered by a conductive heat resistant material, such as Teflon™. As the paper with the toner image is passed through the nip 32, the toner image melts and is permanently fused to the paper 18.

The web cleaning system 30 is spaced from the nip 32 and includes a first web carrying roll 42, mounted on an axial shaft 44, a tension roll 46, mounted on an axial shaft 48, and a second web carrying roll 50, mounted on an axial shaft 52, all of which are rotatably mounted parallel to each other and to the longitudinal axes 34, 36 of the fuser and pressure rolls 26, 28. The tension roll 46 is urged into contact with the fuser roll 26, intermediate the web carrying rolls 42,50, to form a nip 56 by a biasing member, such as by one or more springs 58. The web rolls 42, 50 have a web 60 wrapped and stored thereon. The tension roll 46 may consist of a cylindrically shaped core, formed of a conformable, heat resistant material, such as foam, formed on a steel shaft 48. The web rolls 42, 50 alternately serve as a supply roll and a take up roll such that at any one time, one of the rolls serves as the supply roll and the other as the take up roll.

The replaceable web 60, which has the appropriate texture and toner cleaning characteristics, is mounted at ends thereof to the web rolls 42, 50 and passes through the nip 56, so that the tension roll 46 presses the web 60 against the fuser roll 26. Any suitable web material capable of withstanding fusing temperatures of about 225° C. may be employed. The web material may be any suitable woven or non-woven fabric, so long as it has a surface texture suitable to collect toner from the fuser roll 26 and has a sufficient thickness and strength to prevent the web 60 from being torn when the web is pulled through the nip 56. A typical web may be about 9 meters in length and relatively thin (about 40 μm). Nonwoven rayon, nylon and polyester, as well as some paper products are suitable for forming the web 60. The particular characteristics of any material selected will determine how fast the web may travel. The web 60 may be impregnated or contacted with a liquid, such as suitable lubricant/release agent, which is released on to the fuser roll 26. Suitable liquids include silicone oils. The oil acts as a lubricant and a toner release agent to avoid stripper finger and thermistor wear.

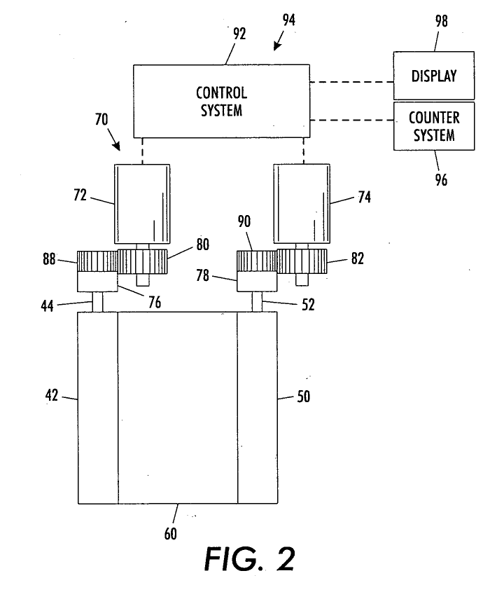

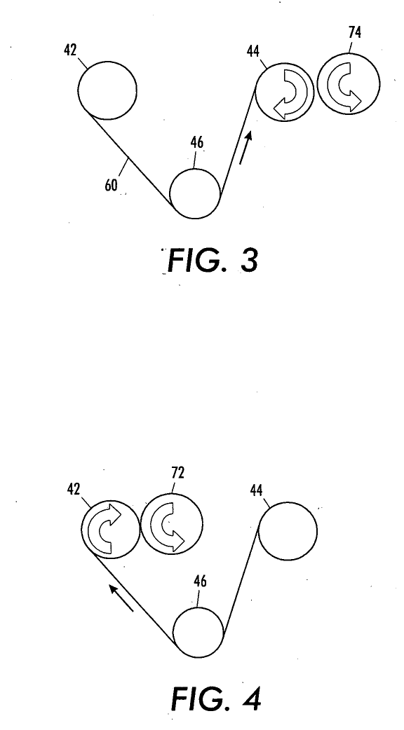

With reference also to FIGS. 2-4, a drive system 70 drives the rolls 42, 50 such that the web 60 is first advanced in the direction of arrow A shown in FIGS. 1 and 3, from the “supply” roll 42 to the “take up” roll 50. When the end of the web is reached, the drive system 70 reverses the direction of advancement of the web 60 and the web is transferred from “supply” roll 50 to “take up” roll 42, as illustrated in FIG. 4. At any given time, a portion of the web 60 within the nip 56 serves to collect toner and other materials which have deposited on the fuser roll 26. As the web advances in the nip 56 in one direction (i.e., parallel to the process direction), a clean portion of the web is progressively brought in contact with the fuser roll 26. When the direction of advancement reverses, the same side of the web is brought into contact with the fuser roll.

The web 60 is advanced by the drive system 70 at a relatively slow rate, as compared with the rotation speed of the fuser roll 26 and/or the pressure roll 18. The difference in speeds of the web to the surface of the fuser roll 16 causes the required friction to enable the texture of the web to clean any toner or other debris from the fuser roll 26. However, the speed of advancement can be higher than in a conventional web cleaning system because the web is reused one or more times. For example, a conventional take up roll may be advanced at about 5 to 20 mm per 1000 copies, e.g., about 17 mm/1000 copies, which equates to about 0.1 revolutions of the take-up roll/minute. The present web may be advanced at from two to ten times this speed, advanced at about 40 to 200 mm per 1000 copies, e.g., about 50-100 mm/1000 copies, which equates to about 0.3-0.6 revolutions of the take-up roll/minute. The web may be advanced continuously or incrementally, e.g. advanced a small increment after each copy or after a number of copies. The web is advanced a distance of for example, greater than a circumference of the fuser roll 26 in the first direction before advancing approximately the same distance in the opposite direction. One of the first and second directions of advancement is opposite to the direction in which the circumference of the fuser roll advances.

The drive system 70 illustrated in FIG. 2 enables both rolls 42, 50 to be selectively driven such that the web 60 is first advanced in one direction and then in the opposite direction. The illustrated drive system 70 includes first and second drive members 72, 74, such as two motors, a first motor 72 associated with the first web roll 42 and a second motor 74 associated with the second web roll 50. Each motor is associated with a respective clutch mechanism 76, 78 which selectively operatively couples the respective motor 72, 74 with the respective drive shaft 44, 52 of the web roll 42, 50. In the illustrated embodiment, each clutch mechanism 76, 78 includes a drive gear 80, 82 carried by an axial drive shaft 84, 86 of the motor 72, 74, and a driven gear 88, 90 carried by the respective drive shaft 44, 52. When the gears of a clutch mechanism mesh, the respective web roll is driven. A control system 92 actuates the first and second motors 72, 74 and/or clutch mechanism 76, 78. When motor 74 is switched on and the clutch mechanism 78 is engaged, the web roll 50 serves as the take up roll, as illustrated in FIG. 3. When the motor 72 is switched on and the clutch 76 engaged, the web roll 42 serves as the take up roll as illustrated in FIG. 4. The control system 92 controls the drive members 72, 74 and/or clutch mechanism 76, 78, such that while the web 60 advances in direction A, drive member 74 operates to rotate the supply roll 50 in the direction shown and during advancement of the web 60 in the reverse direction B, the drive member 72 operates to rotate the supply roll 42 in the direction shown.

The web 60 may be initially loaded on to either of the rolls 42, 50, which serves as the supply roll during the first pass of the web through the nip 56. During the first pass, the web is conveyed to the other roll in the direction of arrow A. During the advancement of the web in the direction of arrow A, roll 50 serves as a take up roll. Once the web 60 has been transferred to the roll 50, leaving only a small tail end attached to supply roll 42, the control system halts rotation of the motor 74 and/or disengages clutch 78, which stops the rotation of the supply roll 50. The control system thereupon actuates motor 72 and/or engages clutch 76 which commences the rotation of roll 42 in the direction shown in FIG. 4 to advance the web in direction B. The roll 42 serves as the take up roll during this period. Once all the web 60 has been rewound on roll 42, leaving only a small tail end attached to supply roll 50, the web may be replaced with a fresh web. Or, the web 60 may be reused by repeating the sequence—feeding the web to roll 50 and back to roll 42, and so forth, a selected number of times. The tension roll 46 is generally not driven during forward or backward motion of the web.

Suitable drive members 72, 74 include electric motors which operate at a velocity which varies according to the diameter of wound up web on the driven (take up) roll. For example, a drive system similar to that disclosed in U.S. Pat. No. 5,049,944 to DeBolt, et al., incorporated by reference, where the duty cycle of the motor is varied by the control system, may be used. An end of web detection system 94 detects when the web is reaching the end and reverses the direction of web advancement. In one embodiment, the end of web detection system incorporates the control system 92, which may determine when the end of the web is approaching so that the motor on the acting take up roll is switched off at the appropriate time before the end of the web is reached.

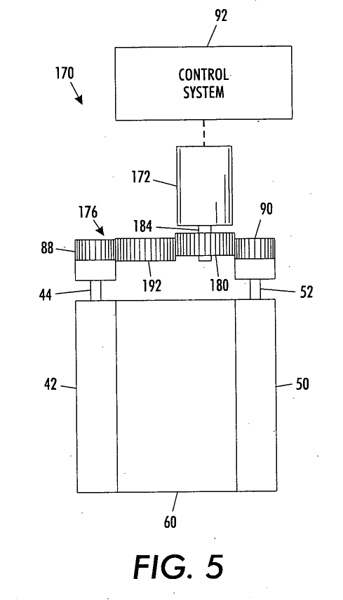

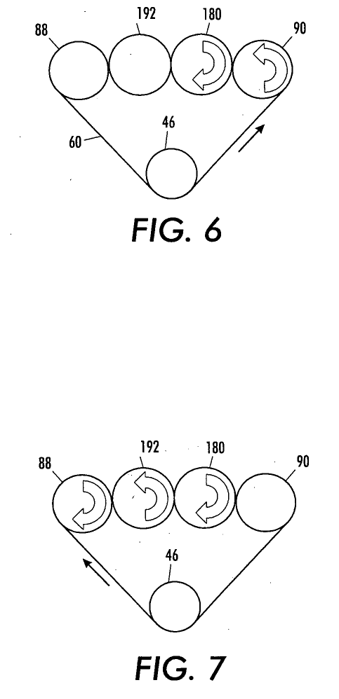

With reference now to FIGS. 5-7, another embodiment of a drive system 170 is shown, where similar elements are accorded the same numerals and new elements are accorded new numerals. The drive system 170 is similar to drive system 70, except as noted. In this embodiment, the drive system includes a single motor 172, which is selectively operatively coupled to both the drive shafts 44, 50. In the embodiment illustrated, the drive system 170 includes a clutch mechanism 176, which selectively couples the motor 172 first to a selected one of the drive shafts 44, 46. Specifically, the clutch mechanism includes a drive gear 180 mounted to an axial drive shaft 184 of the motor and driven gears 88,90, mounted to the drive shafts 44, 52, respectively. Intermediate the gears 180 and 88 is an intermediate gear 192, which allows the motor 172 to rotate in the same direction whether it is driving shaft 44 or shaft 52. The motor 172 is coupled with the drive shaft 52 by engagement of gear 180 with gear 90 for driving the roll 50, as shown in FIG. 6 and subsequently coupled with the shaft 44 by engagement of gear 180 with gear 192 for driving the roll 42, as illustrated in FIG. 7. It will be appreciated that while gears 88 and 192 are not driven in FIG. 6, they still rotate, as the web 60 is pulled from the web roll 42. Similarly gear 90 in FIG. 7 also rotates although not driven. In this embodiment, the motor rotates drive shaft 184 in the same direction, irrespective of the direction in which the web is advanced.

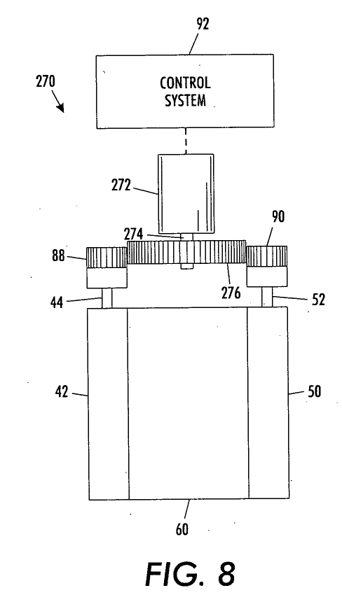

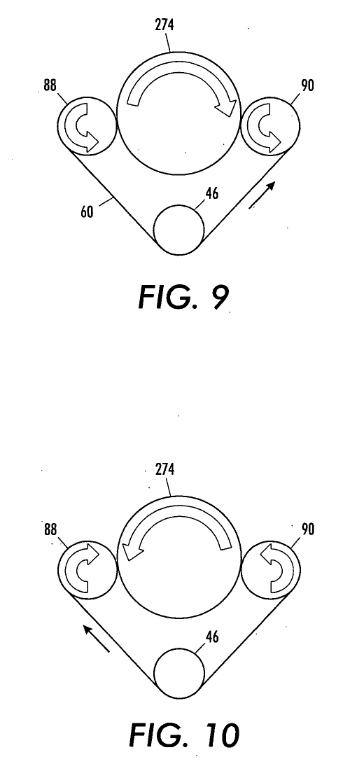

With reference now to FIGS. 8-10, another embodiment of a drive system 270 is shown, where similar elements are accorded the same numerals and new elements are accorded new numerals. The drive system 270 is similar to drive system 170, except as noted. In this embodiment, the drive system includes a single motor 272, which is operatively coupled to both the drive shafts 44, 50. A shaft 274 of the motor carries a drive gear 276, which engages driven gears 88, 90. When the motor is rotated in a first direction (FIG. 9), both driven gears 88, 90 are rotates so that the web moves in one direction. When the direction of the motor 272 is reversed (FIG. 10), the driven gears 88, 88, 90 are driven in the opposite direction so that the direction of web advancement is reversed. The control system 92 determines when the web 60 is reaching the end of its travel and reverses the direction of the motor.

In yet another embodiment (not shown), a motor is operatively coupled with only one of the web rolls. In this embodiment, the motor rotates the first web roll in a first direction to take up the web and advance the web in a first direction. The second web roll is connected with a torsion spring which is wound up as the web advances. The motor is then operated in reverse, allowing the web to be unwound from the first web roll to be taken up by the second web roll which rotates under the force built up in the torsion spring.

In all the above embodiments, the gears rotate around axes parallel with the axes of the web rolls 42, 44.

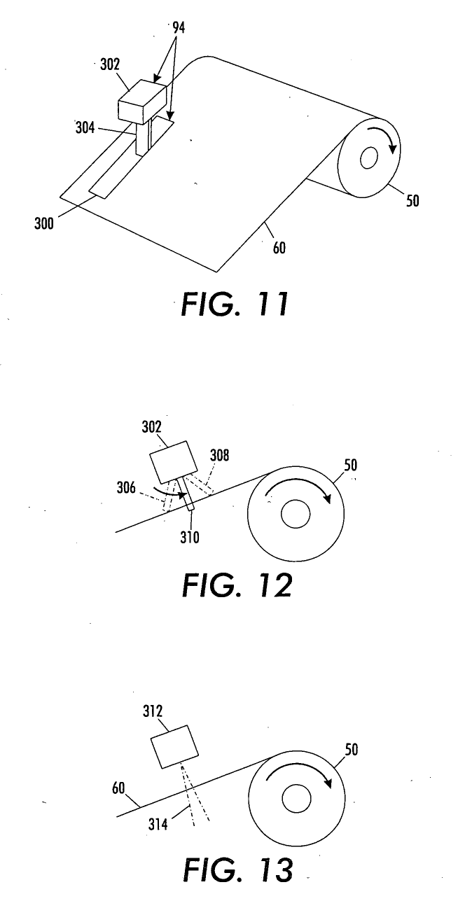

Various methods for determining when the end of the web 60 is approaching are contemplated. In one embodiment, the control system 92 determines when the end of the web is about to be reached from the motor “on time.” In this embodiment, once the motor driving the take up roll has been running for a predetermined time, the direction of web advancement is reversed. In another embodiment, the control system 92 counts the number of prints and reverses the web direction after a predetermined number of prints. In yet another embodiment, illustrated in FIGS. 11-13, the end of web detection system includes an end of web indicator 300, associated with the web, which indicates when the end of the web is approaching. FIG. 11 illustrates an exemplary end of web indicator 300 in the form of a slot in the web. The end of web indicator is detectable by a suitable sensor 302. In the embodiment of FIGS. 11 and 12, the sensor 302 is in the form of a switch which includes a moveable member 304, sized to be received within the slot 300. When the web advances, the member rides over the surface of the web, either in position 306 or position 306, depending on the direction of web advancement (FIG. 12). When the slot 300 reaches the moveable member, a distal end of the moveable member falls into the slot, to position 310, thereby actuating the switch. The switch 302 is in communication with the control system 92. Other suitable end of web indicators comprise machine readable markings on the web, such as colored strips which are detectable by a light or other radiation sensor 312 (FIG. 13) or other suitable sensor. The light sensor emits a beam of radiation which is reflected or transmitted by the indicator and the sensor detects a change in the reflected/emitted light as the indicator 300 is passed. The light sensor 312 of FIG. 13 may also be used with a slot such as that shown in FIG. 11. The end of web detection system 94 may include two sensors and two indicators. For example, an end of web sensor 302, 312 may be positioned proximate each of the web rolls 42, 50 with an end of web indicator located near each end of the web 60.

In other embodiments, the control system 92 monitors the torque in the motor driving the take up roll. As the end of the web is reached, the torque increases significantly, which is a signal to the control system 92 to reverse the direction of advancement.

The control system 92 includes suitable software to maintain a constant web advance rate as the take up diameter increases. In one embodiment, the control system 92 shifts the point at which the web is stopped and reversed with each pass. This is because the averaging effect of multiple passes is reduced at the ends of the web as fewer prints pass through the printer between two consecutive passes. For example, the control system may track the length of web used and utilize an algorithm, which shifts the reusable web range throughout its life.

A counter system 96 (FIG. 2) may be associated with the end of web detection system 94. The counter system is reset each time a fresh web is installed and increments by one for each pass of the web, e.g., each time one of the sensors records that the end of the web is being reached. When the counter reaches a preselected number of passes, the control system provides a signal to a printer display 98, such as an LCD screen, which alerts an operator that the web needs to be replaced or provides other suitable indication that the web has reached the end of its useful life. Other counter systems are contemplated, such as a system which sums the total drive system on time or the total number of copies made since web replacement. The control system 92 and counter 96 may be any suitable device, circuit, or routine that is capable of performing the functions of the respective component and may be embodied, for example in suitable software on a general purpose computer, network, or processing component of the printer.

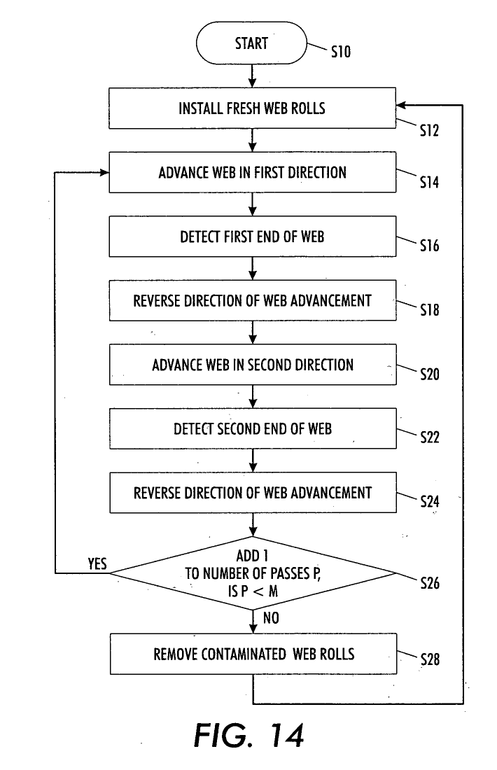

FIG. 14 illustrates the steps of an exemplary web advancement method. It will be appreciated that the steps need not be performed in the order presented and that fewer or more steps may be employed. The method begins at step S10. At step S12 fresh web rolls 26, 28 are installed in the web cleaning system, e.g., by engaging shafts 44, 52 with driven gears 88, 90, such that the web passes around tension roll 46. At step S14 the web is advanced in a first direction. At step S16, the end of web detection system detects that the majority of the web has been transferred from the first roll to the second roll. At step S18, the direction of web advancement is reversed. At step S20, the web is advanced in the second direction. At step S22, the end of web detection system detects that the majority of the web has been transferred back to the first roll. At step S24, the counter optionally counts the number of passes of the web and if it is below a predetermined number, Steps S14 to S22 are repeated. Steps S14 to S22 may be repeated a preselected number of times or until an operator determines that the web needs replacing. In one embodiment, a display 98 on the printer may signal to the operator that the web needs to be replaced. Or, the web rolls may be replaced on a schedule, such as every 100,000 or every 500,000 prints. At step S22, the contaminated web rolls are removed from the cleaning system.

While the web cleaning system 30 is illustrated as being associated with the fuser roll 26, it will be appreciated that in other embodiments, a cleaning system may be associated with the pressure roll 28.

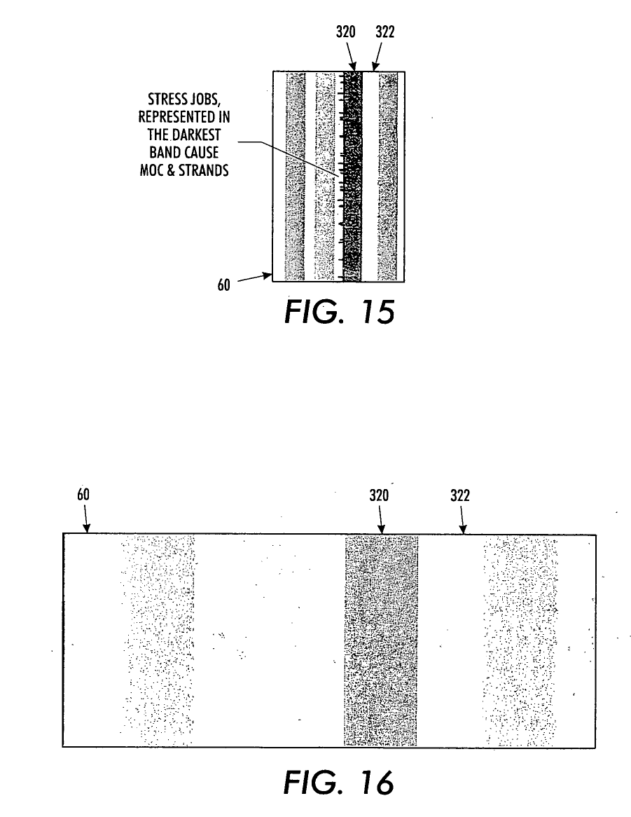

Because the web 60 is reused, the web can travel at much higher speeds than conventional webs which are discarded after a single pass. For example, the web may be advanced at a speed which is at least five times faster than normal web advancement and can be ten times the normal speed or higher. In one embodiment, the web is advanced at a speed of from about 10 to 50 mm per minute, or higher, as compared with a conventional web cleaning system which is generally advanced at about 2-2.5 mm per minute. In this way, during stress jobs, i.e., those which tend to leave the largest toner deposits on the web, the toner is deposited over a much greater length of web than in a conventional system. The distribution of toner is apparent from a comparison of FIGS. 15 and 16. Different job types tend to cause different levels of contamination of the web. FIG. 15 illustrates toner deposits on a typical web 60 after the fuser has been used for a mixture of stress jobs and low-stress jobs, indicated by respective high and low toner areas 320, 322. Area 320 corresponds to an area of high toner saturation of the web 60 and an increased risk of toner retransfer and visible image quality defects. FIG. 16 illustrates an exemplary web 60 in the present system, after it has been used for the same mixture of stress jobs and low-stress jobs illustrated in FIG. 15. However, because of the greater speed of the web, the toner areas 320, 322 are spread over larger areas in FIG. 16. This results in lower toner retransfer to the fuser roll and a concomitant decrease in visible image quality defects. Because the stress jobs are intermittent, the likelihood that a second stress job will coincide with the position of the first stress job 320 when the web is repassed through the web cleaning system 30 is relatively low, and even where it does, will also be spread over a relatively large area. As a result, the number of visible image quality defects is reduced, even where the web is used for longer (i.e., a greater number of sheets printed) than the system of FIG. 15.

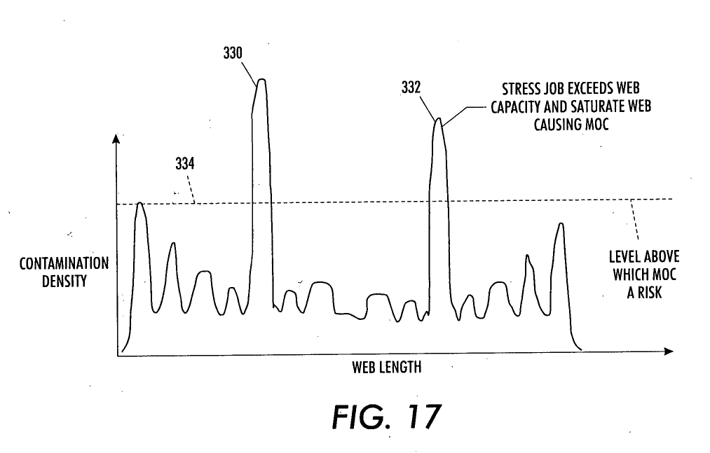

For example, FIG. 17 illustrates an exemplary contamination density for a web which has been used in a conventional web cleaning system during a mixture of stress jobs and low stress jobs. As can be seen, the web experiences peak contamination densities 330, 332, which exceeds a saturation level 334 at which MOC (Marks on Copy) is a risk in two instances. MOC is a defect on the print resulting from a saturated web where toner is not absorbed by the web. Unabsorbed toner stays on the web and can stay in contact with the fuser roll when the fuser roll 28 is stationary. The next time the fuser roll 26 is rotated, part of the unabsorbed toner breaks off the web 60, slips through the nip 56 and is transferred, via nip 32, either directly onto the paper or attached to the pressure roll 28 during a full rotation and onto the backside of the paper.

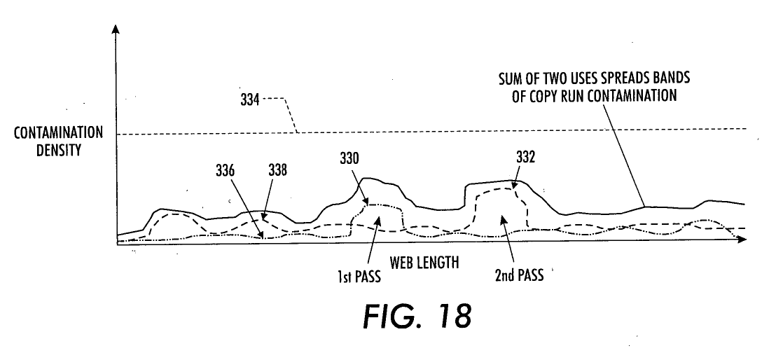

Using the present system, running the web 60 at two to three times the speed, peak 330 occurs in the first pass 336 and peak 332 in the second pass 338, as show in FIG. 18. Both peaks are spread out and well below the saturation level 334. Combining the first and second pass peak contamination densities 330, 332 provides a total contamination density which is well below the level 334. It is to be expected that even with a third and fourth pass for similar print jobs, the web may still be below the saturation level and/or result in fewer visible image quality defects.ams

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A fuser system comprising:
first and second nip rolls being rotably mounted parallel to and in contact with each other to form a nip through which print media with a toner image thereon is passed to fuse the image to the print media;
a cleaning web system for cleaning the first nip roll, the cleaning web system comprising:
first and second rotatable web rolls;
a web which extends between the first and second web rolls and contacts the first nip roll; and
a drive system operatively coupled with at least one of the first and second web rolls for advancing the web in a first direction and thereafter in a second direction opposite the first direction.

2. The fuser system of claim 1, further including a tension roll in engagement with the web intermediate the first and second web rolls, the tension roll biasing the web into frictional contact with the first nip roll.

3. The fuser system of claim 1, further comprising a heater, which heats the first nip roll.

4. The fuser system of claim 1, wherein when the web advances in a first direction, a first of the web rolls serves as a take up roll and when the web advances in the opposite direction, the second web roll serves as the take up roll.

5. The fuser system of claim 1, further comprising a control system which controls the drive system to reverse the direction of advancement when an end of the web is reached.

6. The fuser system of claim 1, further comprising an end of web detection system which detects when an end of the web is approaching.

7. The fuser system of claim 6, wherein the end of web detection system comprises a sensor which senses an indicator associated with the web.

8. The fuser system of claim 7, wherein the indicator comprises a slot.

9. The fuser system of claim 8, wherein the sensor includes a moveable member which is sized to be received by the slot.

10. The fuser system of claim 7, wherein the sensor includes a radiation sensor and the indicator modifies the radiation sensed by the radiation sensor.

11. The fuser system of claim 6, wherein the end of web detection system detects at least one of:
a change in torque of the drive system;
a number of copies printed; and
an on time of the drive system.

12. The fuser system of claim 1, wherein the drive system includes at least one motor.

13. The fuser system of claim 12, wherein the drive system includes a first motor which selectively drives the first web roll and a second motor which selectively drives the second web roll.

14. The fuser system of claim 1, wherein the web comprises a length of fabric impregnated with an oil.

15. A xerographic printer comprising the fusing system of claim 1.

16. A method of cleaning a nip roll of a fuser comprising:
advancing a web in a first direction;
advancing the web in a second direction opposite the first direction;
biasing the web into contact with a rotating nip roll during the advancement of the web in the first and second directions;

17. The method of claim 17, wherein the web is carried by spaced first and second web rolls and wherein the advancing of the web in the first direction includes driving a first of the web rolls and the advancing of the web in the second direction includes driving a second of the web rolls.

18. The method of claim 17, further including detecting when the web is reaching an end and switching from driving a first of the web rolls to driving a second of the web rolls.

19. The method of claim 17, wherein the detecting when the web is reaching an end includes sensing an indicator associated with the end of the web.

20. A web cleaning system comprising:
a length of web;
a first web roll and a second web roll which support ends of the web thereon;
a tension roll, intermediate the first and second web rolls, which biases the web into contact with an associated nip roll;
a drive system operatively connected with the web rolls which advances the web in a first direction then advances the web in a second direction opposite the first direction; and
an end of web detection system, coupled with the drive system, detects an end of the web.

21. The web cleaning system of claim 21, wherein the drive system drives the first web roll in the first direction then drives the second web roll in the second direction.
